(19) United States
(12) Patent Application Publication
(10) Pub. No.: US 2004/0219402 A1
(43) Pub. Date: Nov. 4, 2004

(54) Method for supplying an oxygenated medium to a cathode area of at least one fuel cell

(75) Inventor: Rainer Autenrieth, Grossbottwar (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/819,863

(22) Filed: Apr. 7, 2004

(30) Foreign Application Priority Data
Apr. 7, 2003 (DE) DE 103 15 699.2

(51) Int. Cl. H01M 8/04

(52) U.S. Cl. 429/13; 429/23

(57) ABSTRACT

A method for supplying a cathode area of at least one fuel cell with an oxygenated medium, in particular air, using at least one electrically powered delivery device having a variable delivery rate. A current generated by the at least one fuel cell and a current consumed by the at least one delivery device are determined. The delivery rate of the at least one delivery device is varied so that a maximum difference between the current generated by the at least one fuel cell and the current consumed by the at least one delivery device is established.

Priority is claimed to German Patent Application No. DE 103 15 699.2 that was filed on Apr. 7, 2003,the entire disclosure of which is incorporated by reference herein.

The present invention relates to a method for supplying a cathode area of at least one fuel cell with an oxygenated medium and to the use of that method.

### BACKGROUND

U.S. Pat. No. 5,991,670 describes a corresponding system for controlling the electric output power and the air supply of a fuel cell and/or a fuel cell stack composed of multiple fuel cells. The system described there is designed so that the delivery rate of the air supply is regulated on the basis of the rotational speed of a compressor so that the fuel cell is able to cover the electric power demand.

One disadvantage of this method described in the US patent cited above is that the load and operating states of this fuel cell are varied more or less continuously and adapted to the power required by an electric drive in the specific case of this publication. This constant dynamic change in the load states constitutes a similarly high load for the fuel cell. The lifetime of the fuel cell and its components, e.g., the diaphragm in the case of a PEM fuel cell stack, suffer under such a dynamic variations in load states so that components are very frequently damaged and/or even fail after only a short fuel cell operating time.

Another disadvantage of the system according to U.S. Pat. No. 5,991,670 cited above is that the fuel cell is not operated at its maximum possible efficiency over long periods and therefore, ultimately, energy is wasted.

Despite these disadvantages, U.S. Pat. No. 5,991,670 provides an improvement in comparison with the general related art in which air ratio λ is used for control and/or regulation. Such systems require very complex sensors, e.g., air mass flow meters, flow meters or the like, but these sensors require a large installation space, result in high costs and also have a negative effect on the reliability of the overall system.

### SUMMARY OF THE INVENTION

An object of the present invention is to provide a method for supplying a cathode area of at least one fuel cell with an oxygenated medium so as to achieve high energy utilization with relatively low effort with regard to the sensors in a type of operation that is gentle on the fuel cells.

The present invention provides a method for supplying an oxygenated medium to a cathode area of at least one fuel cell using an electrically driven delivery device. The method includes the steps of: determining a generating current generated by the at least one fuel cell; determining a consumption current consumed by the delivery device; and varying a delivery rate of the delivery device so as to establish a maximum difference between the generating current and the consumption current.

Varying the delivery rate so that the difference between the current generated and the current consumed is set at a maximum permits a regulation and/or control in which a low sensor system complexity is required. With the method according to the present invention, it is sufficient to determine the two current values mentioned above, so that complex measuring equipment such as air mass flow meters, flow meters and the like may be omitted entirely. This difference mentioned, which is virtually equivalent to the net current and thus ultimately also the net power output of the fuel cell, is formed from the two measured currents. It is therefore also sufficient to measure only two of the currents to obtain all the necessary information. This minimizes the measuring complexity.

This consideration thus implicitly includes the fact that the electric power consumption of the air supply delivery device represents the greatest parasitic electric power of a fuel cell system. Optimizing the difference, i.e., the net current, i.e., the net power of the at least one fuel cell up to a maximum, at the same time represents an optimization of the system of the at least one fuel cell and the at least one delivery device up to its maximum efficiency because both the fuel cell power and the total essential parasitic electric power of the supply elements are taken into account.

Achieving the object of the present invention thus logically presupposes that a sufficient amount of fuel, usually in the form of hydrogen, is always available for the fuel cell. However, an excess or a deficiency in turn affects the electric current generated by the fuel cell, so that here again, there is an appropriate adaptation of the air supply and the fuel cell system with regard to the available fuel through the method according to the present invention.

In the method according to the present invention, the fuel cell is operated in an approximately steady state over a long period of time, so that unusual loads which could damage the fuel cell such as those which occur due to dynamic operation in the method according to the related art may be ruled out or at least minimized. The method according to the present invention thus makes it possible to construct and operate a compact, sturdy and reliable fuel cell system with minimal complexity with regard to the sensors and minimum installation space and cost.

A particularly advantageous use of the method according to the present invention is in the generation of power in a means of transportation used on water, land, or air.

Use of the method according to the present invention is recommended in particular with fuel cell systems of which high demands are made with regard to reliability, sturdiness and installation space as well as cost. Such systems are generally to be found in transportation means for use on water, on land and in the air, e.g., in motor vehicles. Since a goal is to increase maintenance intervals compared with stationary systems, e.g., power plants or the like, and much higher demands are to be made regarding minimization of the installation space and weight, the method according to the present invention is used here ideally because of the advantages achieved. Likewise, because of the large number of fuel cell systems to be expected in such transportation facilities, cost plays a crucial role, so that another of the advantages listed above may be manifested ideally.

Another advantageous use of the method according to the present invention is in a fuel cell system that includes at least one device for storing electric power.

Such a design of a fuel cell system and an electric energy storage device such as that known from DE 101 25 106 A1, for example, is another very favorable option for using the method according to the present invention. The combined design of the fuel cell and at least one electric energy storage device makes it possible for the dynamic load requirements that may be made of the fuel cell system and definitely must be made of the fuel cell system in particular when used as a power source for propelling a motor vehicle, to be covered by the electric energy storage device. The fuel cell may be operated “in the background” of such a system in its optimum operation with regard to the power yield to be achieved, i.e., at maximum net power output in the method according to the present invention.

### BRIEF DESCRIPTION OF THE DRAWINGS

Other advantageous embodiments of the method according to the present invention are described in the claims and with reference to the exemplary embodiment described below on the basis of the drawings, in which:

FIG. 1 shows a basic diagram of a fuel cell, i.e., a fuel cell stack, having an air supply for use with the method according to the present invention; and

FIG. 2 shows a diagram in which the electric power has been plotted as a function of the amount of oxygenated medium conveyed into the cathode area of the fuel cell.

### DETAILED DESCRIPTION

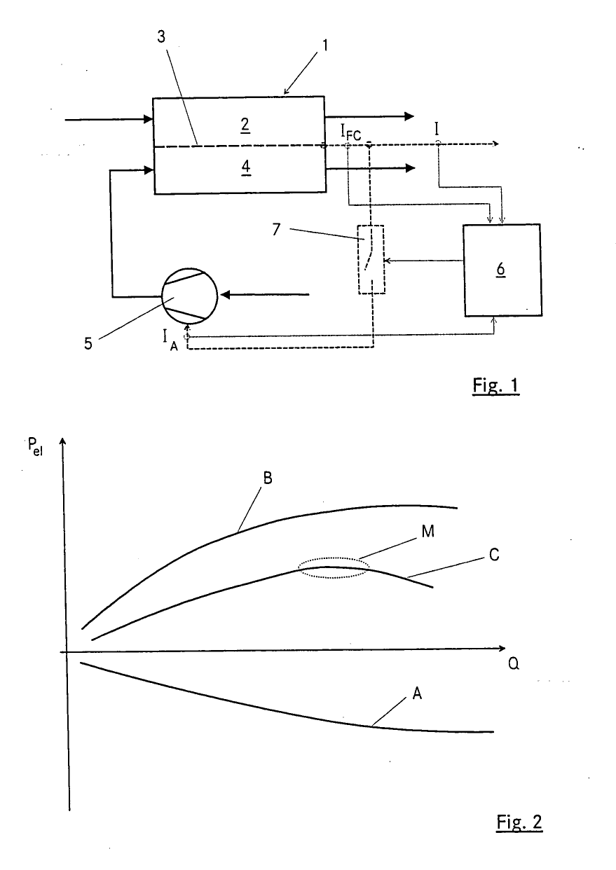

FIG. 1 shows a fuel cell 1, i.e., a fuel cell stack 1, as a basic diagram. An anode area 2 in fuel cell stack 1 is separated from a cathode area 4 of fuel cell 1, i.e., fuel cell stack 1 by a proton-conducting diaphragm. This design of fuel cell 1 as a PEM fuel cell is presented here merely as an example and does not restrict the scope of the present invention to such a fuel cell system.

Cathode area 4 of fuel cell 1 is supplied with an oxygenated medium, in particular air. This air is supplied via an electrically driven delivery device 5 which has a variable delivery rate. This may be accomplished in particular by increasing the rotational speed of delivery device 5, which is designed as a compressor, for example, or through some other suitable measures. Depending on the delivery rate, delivery device 5 consumes different amounts of current I_{A} which increase with the delivery rate.

Fuel cell 1, i.e., fuel cell stack 1, itself generates electric current I_{FC} from the oxygenated medium, in particular air, supplied to cathode area 4 and from a medium suitable for reduction, usually hydrogen in the case of a PEM fuel cell, supplied to anode area 2; this hydrogen may come from a storage device, a gas generating system or the like. This current I_{FC} generated by fuel cell 1 may be used to operate electric power consuming devices. Such electric power consumers in the system described here as an example are typically electric power consumers in a motor vehicle, e.g., electric motor power consumers for the vehicle drive and/or other power consumers in a vehicle, such as air conditioning systems, navigation systems, communications systems or the like. For the example described here, it does not matter whether fuel cell 1 is part of a drive power supplier or part of an auxiliary energy producer (APU=auxiliary power unit).

In addition to providing electric current, i.e., electric power, the two of which are equivalent at a constant voltage in the system, current I_{A} which is needed for delivery device 5 is also obtained from current I_{FC} generated by fuel cell 1. Remaining net current I available for electric power consuming devices after this consumption of current I_{A} for delivery device 5 is thus formed from the difference between current I_{FC} generated by fuel cell 1 and current I_{A} consumed by delivery device 5. In regular operation of fuel cell 1, the current available for delivery device 5 and thus ultimately its delivery rate are varied, so that a maximum net current I, i.e., the difference between currents I_{FC} and I_{A}, is always established during the entire operation. This makes it possible to ensure that fuel cell 1 is always operated at the best possible energy yield, taking into account the parasitic electric power consumption by delivery device 5.

This optimization of the system by influencing the air supply to cathode area 4 of fuel cell 1 may be accomplished by a suitable control or regulating system 6 in FIG. 1. Control or regulating system 6 includes at least two of currents I, I_{FC} and I_{A}. It also controls and/or regulates the power supply to delivery device 5 and thus its delivery rate. In the basic example depicted in FIG. 1, this is accomplished by a switching device 7, e.g., a MOSFET-type electronic switch or the like.

FIG. 2 shows a diagram of electric power output Pₑₗ which ultimately corresponds to the currents mentioned above at a constant voltage, plotted as a function of quantity Q of oxygenated medium delivered, i.e., in particular quantity Q of air. The power consumption by delivery device 5 corresponds to line A, while the power output of fuel cell 1 corresponds to line B. The difference between these power outputs is represented by the line for net power C, which is essentially proportional to net current I.

This line C for the net power output shows that there is a maximum for the net power output and thus also for net current I, which is indicated here in the area labeled as M. The goal of this method is to supply the air via delivery device 5 to permit operation of fuel cell 1 in range M. As mentioned previously, this is accomplished by regulating the delivery rate, which is represented here by quantity Q of oxygenated medium delivered, so that a maximum net power output, i.e., a maximum net current I is established.

A first possibility for implementing this is to divide the method into multiple steps, with current I_{FC} generated by fuel cell 1 being measured in a first method step. In a second step, a delivery rate of delivery device 5, which is proportional to this measured current I_{FC}, is set, the ratio of current I_{A} to the total current generated being taken into account by a proportionality factor. In the next step, net current I at this predefined delivery rate is determined, and in the following step, the power output determined above for the delivery rate is multiplied by a correction factor which is advisably predefined as being one at the start of the system to yield a corrected value. If a higher net current I is obtained with this corrected value of the delivery rate, then the corrected value is used again as the initial value. However, if a lower net current I is obtained, the original initial value is retained and the correction factor is adjusted again, and it is advisable in particular to adjust this correction factor so that when the initial value has previously been increased by the correction factor, it is now reduced and vice versa.

This optimization may proceed continuously so that ultimately an optimum operating point is established in the sense of the method according to the present invention, i.e., an operating point at an optimum net current I, i.e., net power output, of fuel cell 1.

In addition to the method described here, it is of course also possible to regulate the correction value starting from a starting value, e.g., the value of 1 described here, to a correction value which ensures a maximum net current I by conventional regulating methods. To do so, it is necessary only to replace the last method step in the above-described embodiment by such a conventional regulating method. For example, such a regulating method may be a PID regulation of the correction value to a maximum net current I.

To ensure that the entire system remains within reasonable delivery rate limits, it is advisable to use the method only between a predefined upper limit and a predefined lower limit. However, these limits may be determined as a function of the size of the system. These limits make it possible to ensure that the method described here is functioning reliably and that no critical situations occur, such as an increase in current I_{A} to increase the delivery rate to an intensity that would cause electric or mechanical damage to delivery device 5. Throttling of the delivery rate to zero may also be assumed to be inappropriate for operation as intended. It is prevented by the lower limit.

Otherwise a regulating system that operates in a simple and reliable manner and responds appropriately even in the event of trouble, e.g., a drop in current I_{FC} due to a failure of the hydrogen supply may be implemented using a minimum sensor complexity by the method described here because the air supply is then also throttled by delivery device 5 to optimize net current I.

In addition to this very simple and reliable regulating system, the proportionality factor between current I_{FC} generated by at least one fuel cell 1 and the initial value of the delivery rate is varied as a function of current I_{A} consumed by delivery device 5 or current I_{FC} generated by fuel cell 1, so it is possible to respond to corresponding operating states.

Separating the proportionality factor from the correction factor as described above yields the result that in the case of a load jump, for example, the information about the optimum operating point which is collected in the correction factor and takes into account the appropriate ambient conditions, may be retained.

Precisely these ambient conditions such as temperature and humidity also have an influence on the power characteristic to a certain extent, as shown in FIG. 2. By optimization to maximum net current I as proposed here, these ambient conditions are taken into account implicitly, however, because the system is regulated at the greatest possible net current I in the prevailing operating state. This eliminates the need for a sensor system for taking into account ambient conditions or the like, such as that conventionally used with some systems in the related art.

Use of the method described here is particularly favorable when fuel cell 1 may not be operated highly dynamically but instead more or less in a steady-state operation over great ranges of its operation. This is the case when fuel cell 1 is operated in a structure designed as described in DE 101 25 106 A1 in particular. In this combination of fuel cell 1 with an electric energy storage device, more or less continuous operation of fuel cell 1 may be ensured, thus ensuring a correspondingly high efficiency of the system with use of the method described here. Dynamic demands made on the system by driving operation, for example, may then be compensated largely by the electric energy storage device, so that a very favorable system having a high system efficiency may be implemented with the help of the method described here.

What is claimed is:

1. A method for supplying an oxygenated medium to a cathode area of at least one fuel cell using an electrically driven delivery device, the method comprising:
determining a generating current generated by the at least one fuel cell;
determining a consumption current consumed by the delivery device; and
varying a delivery rate of the delivery device so as to establish a maximum difference between the generating current and the consumption current.

2. The method as recited in claim 1, further comprising:
(a) measuring a generating current value;
(b) adjusting an initial delivery rate for the delivery device in proportion to the generating current value, the initial delivery rate corresponding to an initial consumption current value;
(c) determining a first net current value as a difference between the generating current value and the initial consumption current value;
(d) multiplying the initial consumption current value by a correction factor to yield a corrected consumption current value;
(e) determining a second net current value as a difference between the generating current value and the corrected consumption current value; and
(f) comparing the second net current value to the first net current value, wherein when the second net current value is greater than the first net current value, setting the initial consumption current value equal to the corrected consumption current value, and when the second net current value is not greater than the first net current value, retaining the initial consumption current value and adjusting a value of the correction factor to a new correction factor value.

3. The method as recited in claim 2, wherein the adjusting of the correction factor includes setting the new correction value to be greater than one when the previous correction factor value was less than one, and setting the new correction value to be less than one when the previous correction factor value was greater than one.

4. The method as recited in claim 2, further comprising continuously repeating steps (c) through (f).

5. The method as recited in claim 1, further comprising:
(a) measuring a generating current value;
(b) adjusting an initial delivery rate for the delivery device in proportion to the initial generating current value, the initial delivery rate corresponding to an initial consumption current value;
(c) determining a first net current value as a difference between the generating current value and the initial consumption current value;
(d) multiplying the initial consumption current value by a correction factor to yield a corrected consumption current value;
(e) determining a second net current value as a difference between the generating current value and the corrected consumption current value; and
(f) regulating the correction factor using a regulating routine so as to maximize the second net current value.

6. The method as recited in claim 5, wherein the regulating routine includes a PID regulation.

7. The method as recited in claim 2, wherein a proportionality factor between the generating current value and the delivery rate is varied as a function of at least one of the generating current and the consumption current.

8. The method as recited in claim 1 wherein a lower limit value of the delivery rate and an upper limit value of the delivery rate are predefined, and an actual value of the delivery rate is between the lower and the upper limit values during regular operation of the at least one fuel cell.

9. The method as recited in claim 2, wherein the at least one fuel cell is generates power for a transportation device used on water, on land, or in the air.

10. The method as recited in claim 2, wherein the at least one fuel cell is associated with at least one device for storing electric power.
